(19) United States
(12) Patent Application Publication
(10) Pub. No.: US 2025/0306641 A1
(43) Pub. Date: Oct. 2, 2025

(54) INPUT APPARATUS AND RETRACTABLE CONNECTION DEVICE

(71) Applicant: Chicony Electronics Co., Ltd., New Taipei City (TW)

(72) Inventors: Kai-Yu Cheng, New Taipei City (TW); Huai-Chih Chen, New Taipei City (TW)

(21) Appl. No.: 19/073,716

(22) Filed: Mar. 7, 2025

Related U.S. Application Data
(60) Provisional application No. 63/572,928, filed on Apr. 2, 2024.

(30) Foreign Application Priority Data
Aug. 2, 2024 (TW) 113129097

(51) Int. Cl. G06F 1/16

(52) U.S. Cl. CPC G06F 1/1654

(57) ABSTRACT

An input apparatus includes a retractable connection device and an input unit. The retractable connection device includes a substrate, a movable member, a flexible sheet, a device connection member, and a plurality of elastic members. The movable member is on the substrate, and the movable member is slidable with respect to the substrate along a moving direction. The flexible sheet has a first side and a second side opposite to the first side, and the first side is connected to the movable member. The device connection member is connected to the second side of the flexible sheet. The elastic members are between the movable member and the substrate and are spaced apart from each other. Each of the elastic members generates an elastic pulling force toward the substrate for the movable member. The input unit is connected to the substrate of the retractable connection device.

### CROSS-REFERENCE TO RELATED APPLICATIONS

This application claims the benefit of U.S. provisional application Ser. No. 63/572,928, filed on Apr. 2, 2024 and claims the priority of patent application Ser. No. 11/312,9097 filed in Taiwan, R.O.C. on Aug. 2, 2024. The entirety of the above-mentioned patent applications are hereby incorporated by references herein and made a part of the specification.

### BACKGROUND

### Technical Field

The instant disclosure relates to a connection device, in particular, to a retractable connection device.

### Related Art

Along with developments of technology, tablet-type computers (For example, smart phones or tablets) have already become common electronic devices for nowadays people. To allow the tablet-type computers to be protected or to be provided with extension functions, the user usually connects the tablet-type computer to an extension device (for example, a protective cover or a keyboard).

### SUMMARY

In general, as known to the inventor, a flexible sheet is applied as a connection member between the tablet-type computer and the extension device, so that the extension device can be swung with respect to the tablet-type computer using the flexible sheet, and the assembly of the tablet-type computer and the extension device is configured as a folded status or an expanded status. However, because the length of the flexible sheet is fixed, no matter the assembly is configured as the folded status or the expanded status, the flexible sheet is apparently exposed out of the assembly. For example, when the assembly of the tablet-type computer and the extension device is configured as the folded status, the flexible sheet is bent into a U-shaped structure and protrudes out of one side of the extension device. As a result, the exposed flexible sheet will influence the overall aesthetics of the assembly and the flexible sheet may be damaged due to wearing or pulling of foreign objects.

In view of this, in one embodiment, a retractable connection device adapted to be assembled with an electronic device is provided. The retractable connection device comprises a substrate, a movable member, a flexible sheet, a device connection member, and a plurality of elastic members. The movable member is on the substrate, and the movable member is slidable with respect to the substrate along a moving direction. The flexible sheet has a first side and a second side opposite to the first side, and the first side is connected to the movable member. The device connection member is connected to the second side of the flexible sheet. The elastic members are between the movable member and the substrate and are spaced apart from each other. Each of the elastic members generates an elastic pulling force toward the substrate for the movable member.

In another embodiment, an input apparatus adapted to be assembled with an electronic device is provided and comprises an aforementioned retractable connection device and an input unit, and the input unit is connected to the substrate of the retractable connection device.

As above, according to the retractable connection device of one or some embodiments of the instant disclosure, the flexible sheet is connected to the substrate through the movable member and the elastic members, so that the flexible sheet can be retractably moved with respect to the substrate. Therefore, when the retractable connection device is assembled with an electronic device and an extension device for the electronic device, no matter the assembly of the electronic device and the extension device is configured as an expanded status, a folded status, or other application statuses, the length of the portion of the flexible sheet exposed from the electronic device and the length of the portion of the flexible sheet exposed from the extension device can be both greatly reduced. Therefore, the overall aesthetics of the assembly can be ensured, and the flexible sheet is not prone to be damaged.

### BRIEF DESCRIPTION OF THE DRAWINGS

The disclosure will become more fully understood from the detailed description given herein below for illustration only, and thus not limitative of the disclosure, wherein:

FIG. 1 illustrates an application schematic view of a retractable connection device according to an exemplary embodiment of the instant disclosure;

FIG. 2 illustrates a perspective view of a retractable connection device according to a first embodiment of the instant disclosure;

FIG. 3 illustrates an exploded view of the retractable connection device of the first embodiment of the instant disclosure;

FIG. 4 illustrates an enlarged partial exploded view of the retractable connection device of the first embodiment of the instant disclosure;

FIG. 5 illustrates a plan view of the retractable connection device of the first embodiment of the instant disclosure;

FIG. 6 illustrates a schematic view showing the retractable operation of the flexible sheet of the retractable connection device of the first embodiment of the instant disclosure;

FIG. 7 illustrates a schematic view showing the operation of the retractable connection device according to some embodiments of the instant disclosure;

FIG. 8 illustrates a perspective view of a retractable connection device according to a second embodiment of the instant disclosure;

FIG. 9 illustrates an enlarged partial exploded view of the retractable connection device of the second embodiment of the instant disclosure;

FIG. 10 illustrates an enlarged partial plan view of the retractable connection device of the second embodiment of the instant disclosure;

FIG. 11 illustrates a schematic view showing the retractable operation of the flexible sheet of the retractable connection device of the second embodiment of the instant disclosure;

FIG. 12 illustrates a plan view of a retractable connection device according to a third embodiment of the instant disclosure;

FIG. 13 illustrates a schematic view showing the retractable operation of the flexible sheet of the retractable connection device of the third embodiment of the instant disclosure;

FIG. 14 illustrates a perspective view of a retractable connection device according to a fourth embodiment of the instant disclosure;

FIG. 15 illustrates an enlarged partial perspective view of the retractable connection device of the fourth embodiment of the instant disclosure;

FIG. 16 illustrates an enlarged partial exploded view of the retractable connection device of the fourth embodiment of the instant disclosure;

FIG. 17 illustrates a partial plan view of the retractable connection device of the fourth embodiment of the instant disclosure;

FIG. 18 illustrates a schematic view showing the retractable operation of the flexible sheet of the retractable connection device of the fourth embodiment of the instant disclosure;

FIG. 19 illustrates a perspective view of a retractable connection device according to a fifth embodiment of the instant disclosure;

FIG. 20 illustrates an enlarged partial perspective view of the retractable connection device of the fifth embodiment of the instant disclosure;

FIG. 21 illustrates an enlarged partial exploded view of the retractable connection device of the fifth embodiment of the instant disclosure;

FIG. 22 illustrates a cross-sectional view of the retractable connection device of the fifth embodiment of the instant disclosure; and

FIG. 23 illustrates a schematic view showing the retractable operation of the flexible sheet of the retractable connection device of the fifth embodiment of the instant disclosure.

### DETAILED DESCRIPTION

It is noted that, in the embodiments, the terms “first” and “second” are provided to describe different elements, and these elements are not thus limited by using these terms. Furthermore, for the sake of convenience and clarity in the description, thickness or sizes of the elements in the drawings illustrated in an exaggerated, omitted, or general manner are used to help a person skilled in the art with comprehension and reading, and the sizes of the elements are not completely the actual sizes and are not intended to limit any restraint conditions under which the instant disclosure can be implemented and therefore have no technical significance. Any modification to the structures, change to the proportional relationships, or adjustment on the sizes without affecting the effects and the objectives that can be achieved according to the instant disclosure should fall within the scope of the technical content disclosed by the instant disclosure. In all the drawings, identical symbols are used to denote identical or similar elements.

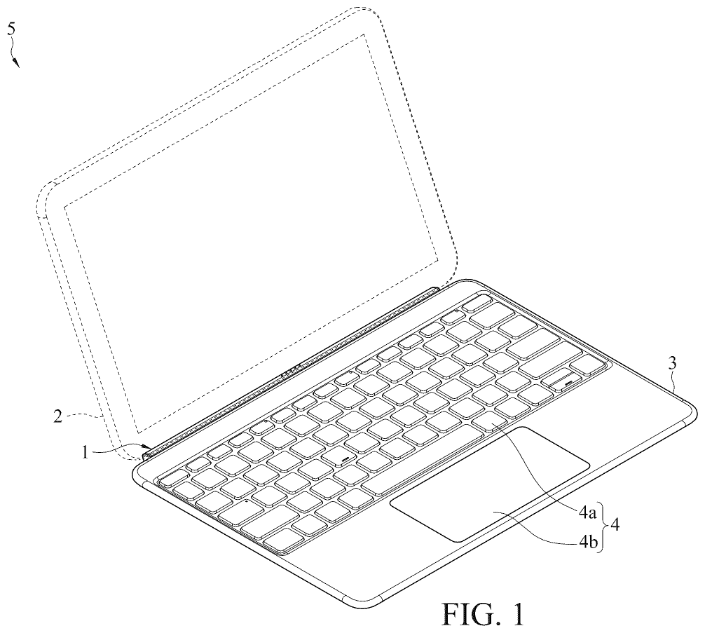

FIG. 1 illustrates an application schematic view of a retractable connection device according to an exemplary embodiment of the instant disclosure. As shown in FIG. 1, in one or some embodiments of the instant disclosure, the retractable connection device 1 is adapted to be assembled with an electronic device 2 (for example, a smart phone or a tablet computer), so that the electronic device 2 is connected to an extension device 3. Therefore, the electronic device 2 can be swung with respect to the extension device 3, and the assembly of the electronic device 2 and the extension device 3 can be configured as an expanded status or a folded status. For example, the extension device 3 may comprise at least one selected from the group consisting of a protective cover, a protective plate, a keyboard, and a touch panel. For instance, as shown in FIG. 1, in this embodiment, the extension device 3 comprises an input unit 4 for the electronic device 2 (in this embodiment, the input unit 4 comprises a keyboard 4a and a touch panel 4b), and the user can control the electronic device 2 to input messages through the input unit 4.

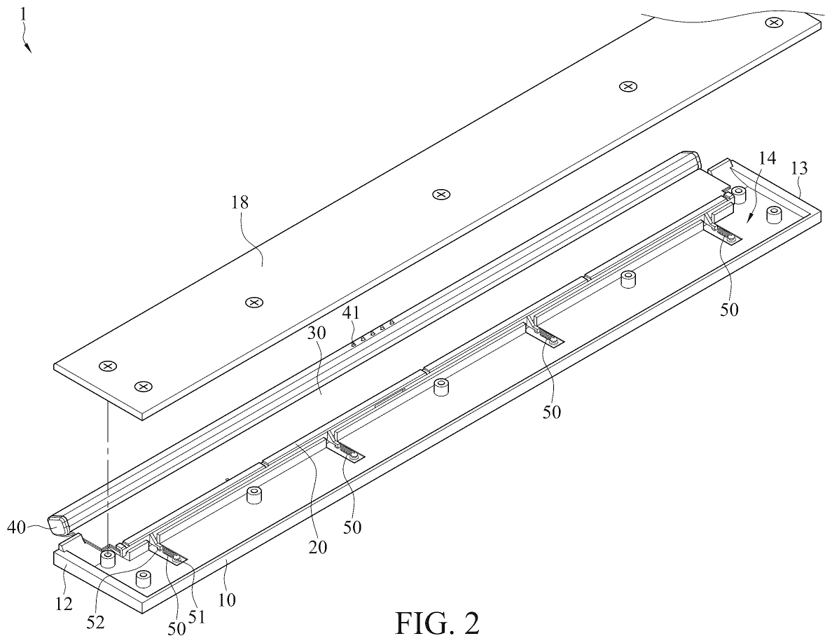

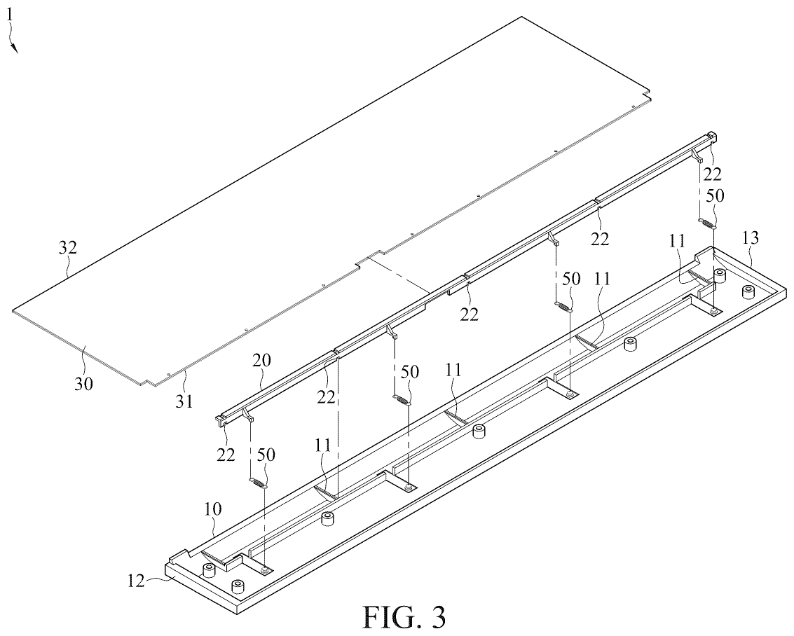

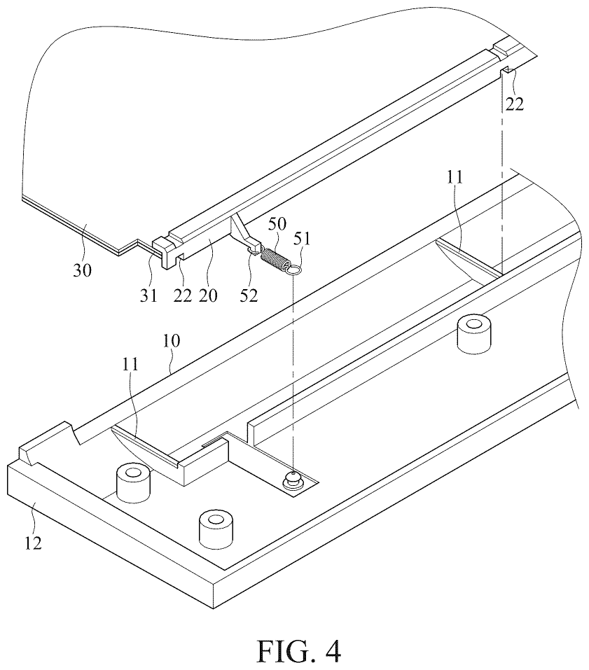

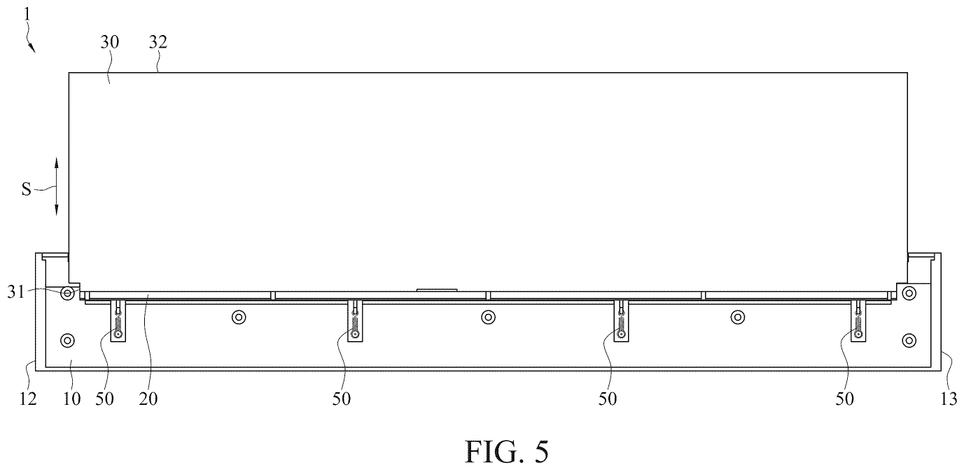

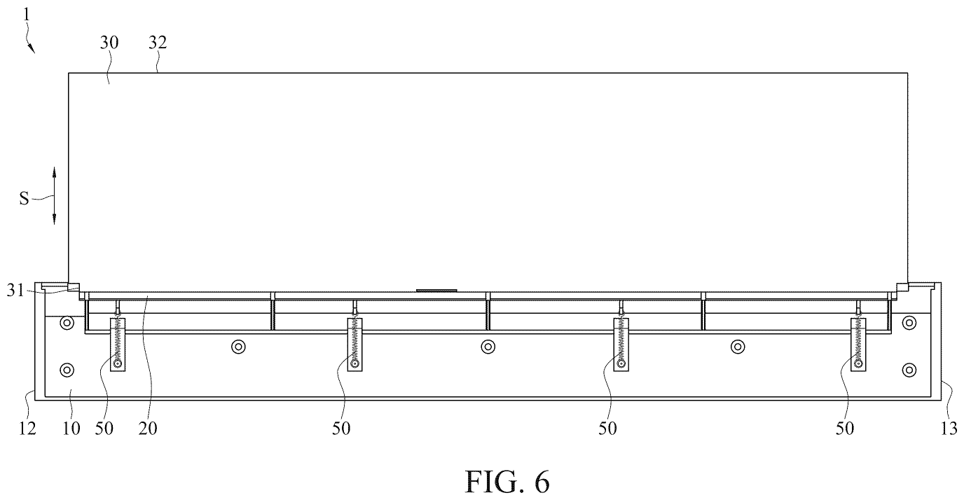

FIG. 2 illustrates a perspective view of a retractable connection device according to a first embodiment of the instant disclosure. FIG. 3 illustrates an exploded view of the retractable connection device of the first embodiment of the instant disclosure. FIG. 4 illustrates an enlarged partial exploded view of the retractable connection device of the first embodiment of the instant disclosure. FIG. 5 illustrates a plan view of the retractable connection device of the first embodiment of the instant disclosure. FIG. 6 illustrates a schematic view showing the retractable operation of the flexible sheet of the retractable connection device of the first embodiment of the instant disclosure. As shown in FIG. 2 to FIG. 6, in the first embodiment, the retractable connection device 1 comprises a substrate 10, a movable member 20, a flexible sheet 30, a device connection member 40, and a plurality of elastic members 50.

As shown in FIG. 1 to FIG. 6, the substrate 10 may be an elongated plate. The retractable connection device 1 can be connected to the extension device 3 to form an input apparatus 5 (as shown in FIG. 1). The substrate 10 is adapted to be assembled with the extension device 3; for example, the substrate 10 may be connected to input unit 4 of the extension device 3, but the instant disclosure is not limited thereto. In some embodiments, the substrate 10 may be a portion of the extension device 3; for example, the substrate 10 may be the plate member of the protective cover, or the substrate 10 may be a portion of the housing of the extension device 3.

As shown in FIG. 2 to FIG. 6, the movable member 20 may be an elongated bar or plate on the substrate 10, and the movable member 20 is slidable with respect to the substrate 10 along a moving direction S (as shown in FIG. 5 and FIG. 6). In this embodiment, the moving direction S is perpendicular to an extension direction of the substrate 10 and an extension direction of the movable member 20, but the instant disclosure is not limited thereto.

As shown in FIG. 2 to FIG. 6, in this embodiment, the substrate 10 has a recessed space 14, and the movable member 20 is in the recessed space 14 of the substrate 10. Moreover, the substrate 10 is provided with at least one first guiding member 11; in this embodiment, the first guiding member 11 is a guiding rib, and the substrate 10 is provided with a plurality of the first guiding members 11 spaced apart from each other. The movable member 20 is provided with a second guiding member 22; in this embodiment, the second guiding member 20 is a guiding groove, and the number and the position of the second guiding members 22 correspond to the number and the position of the first guiding members 11. The first guiding member 11 and the second guiding member 22 extend along the moving direction S, and each of the second guiding members 22 is slidably connected to a corresponding one of the first guiding members 11. Therefore, the movable member 20 can be guided by the first guiding members 11 and the second guiding members 22, so that the movement of the movable member 20 relative to the substrate 10 can be performed more stably, and wobbling or deflection of the moving member 20 does not occur easily. However, it is understood that the foregoing embodiments are provided just for illustrative purposes. In some embodiments, the structure of the first guiding member 11 and the structure of the second guiding member 22 may be exchanged with each other; for example, the first guiding member 11 may be a guiding groove, and the second guiding member 22 may be a guiding rib.

As shown in FIG. 2 to FIG. 6, the flexible sheet 30 may be made of a flexible material; for example, the flexible material may be leather, silicone, plastic, or other soft materials, so that the flexible sheet 30 can be bent freely when the flexible sheet 30 is applied with a force. The flexible sheet 30 has a first side 31 and a second side 32 opposite to the first side 31. The first side 31 is fixed to the movable member 20, so that a region of the flexible sheet 30 adjacent to the first side 31 is within or on the substrate 10. Moreover, because the flexible sheet 30 is connected to the movable member 20, the flexible sheet 30 can slide with respect to the substrate 10 along the moving direction S to move close to or away from the substrate 10 when the flexible sheet 30 is applied with a force. In some embodiments, the first side 31 of the flexible sheet 30 may be fixed on the movable member 20 through locking, engaging, adhering, or other manners, but the instant disclosure is not limited thereto.

As shown in FIG. 2 and FIG. 3 in this embodiment, the retractable connection device 1 may comprise a cover member 18. The cover member 18 is fixed on the substrate 10, so that a receiving space can be formed between the cover member 18 and the substrate 10. The movable member 20 and the first side 31 of the flexible sheet 30 may be arranged in the receiving space between the cover member 18 and the substrate 10, so that the first side 31 of the flexible sheet 30 is retained between the cover member 18 and the substrate 10. In some embodiments, the cover member 18 may be a portion of the extension device 3; for example, the cover member 18 may be a portion of the housing of the extension device 3.

As shown in FIG. 2 to FIG. 6, the device connection member 40 is connected to the second side 32 of the flexible sheet 30, and the device connection member 40 is adapted to be assembled with the electronic device 2. In some embodiments, the device connection member 40 may be a bar or plate member, and the electronic device 2 and the device connection member 40 are connected to each other through buckling, embedding, magnetically-adhering or other manners.

As shown in FIG. 2 to FIG. 6, in this embodiment, the device connection member 40 is a bar member, a region of the flexible sheet 30 adjacent to the second side 42 covers and is fixed to an outer portion of the device connection member 40 to improve the aesthetics. Magnetic members may be provided in the device connection member 40, so that the electronic device 2 can be attached to the device connection member 40 and thus connected to the flexible sheet 30. Moreover, in this embodiment, the device connection member 40 has an electrical connector 41 (as shown in FIG. 2). For example, the electrical connector 41 may be a USB connector or a Pogo Pin connector. The electrical connector 41 can be electrically connected to the input unit 4, and the electrical connector 41 can be inserted by the electronic device 2, so that the connection between the electronic device 2 and the device connection member 40 can be more stable. Furthermore, the electronic device 2 can be electrically connected to the input unit 4 through the electrical connector 41, so that the input unit 4 can control the electronic device 2 to input messages. However, it is understood that the foregoing embodiments are provided just for illustrative purposes. In some embodiments, the electronic device 2 and the input unit 4 are connected to each other through wireless communication, and thus the electrical connector 41 of the device connection member 40 can be omitted.

As shown in FIG. 2 to FIG. 6, the elastic members 50 are between the movable member 20 and the substrate 10 and are spaced apart from each other. Each of the elastic members 50 has elasticity and retractability; in other words, in some embodiments, the elastic member 50 is deformed when the elastic member 50 is applied with to an external force, and the elastic member 50 is recovered resiliently when the external force is removed. In this embodiment, each of the elastic members 50 has a first end 51 and a second end 52, the first end 51 is connected to the substrate 10, and the second end 52 is connected to the movable member 20. Therefore, as shown in FIG. 5 and FIG. 6, when the flexible sheet 30 is pulled to be moved toward the direction away from the substrate 10 and stretched out of the substrate 10, the movable member 20 can drive the elastic member 50 to be deformed (as shown in FIG. 6, in this embodiment, the elastic members 50 are tension springs and perform stretching deformation), so that each of the elastic members 50 generates an elastic pulling force toward the substrate 10 for the movable member 20. When the flexible sheet 30 is released and the external force is removed, the elastic pulling force drives the flexible sheet 30 to retract back toward the substrate 10, thereby allowing the elastic members 50 to be recovered resiliently (as shown in FIG. 5).

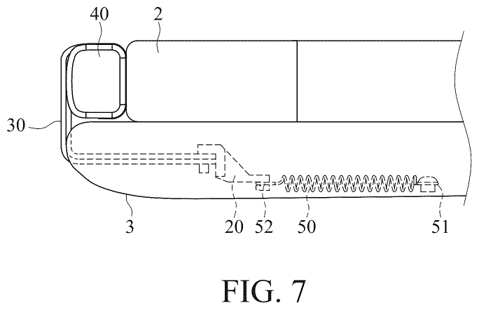

FIG. 7 illustrates a schematic view showing the operation of the retractable connection device according to some embodiments of the instant disclosure. As above, according to the retractable connection device 1 of one or some embodiments of the instant disclosure, when the retractable connection device 1 is assembled with the electronic device 2 and the extension device 3, no matter the assembly of the electronic device 2 and the extension device 3 is configured as an expanded status, a folded status, or other application statuses, the elastic force of each of the elastic members 50 allows the length of the portion of the flexible sheet 30 exposed from the electronic device 2 and the length of the portion of the flexible sheet 30 exposed from the extension device 3 to be both greatly reduced. Therefore, the overall aesthetics of the assembly can be ensured, and the flexible sheet 30 is not prone to be damaged. For example, as shown in FIG. 1, when the assembly of the electronic device 2 and the extension device 3 is configured as an expanded status, most regions of the flexible sheet 30 can be retracted inside the substrate 10 or the extension device 3. Alternatively, in some embodiments, during the expanding process of the assembly of the electronic device 2 and the extension device 3, the user can apply a force to pull the flexible sheet 30 from the substrate 10 or from the extension device 3, so that the electronic device 2 can be swung with respect to the extension device 3 conveniently. Further, as shown in FIG. 7, when the assembly of the electronic device 2 and the extension device 3 is configured as a folded status, each of the elastic members 50 can pull a residual portion of the flexible sheet 30 back to the substrate 10 or the extension device 3, so that the length of the portion of the flexible sheet 30 exposed from the substrate 10 or the length of the portion of the flexible sheet 30 exposed from the extension device 3 can be both greatly reduced.

As shown in FIG. 2 to FIG. 6, in this embodiment, each of the elastic members 50 is a tension spring. The first end 51 of each of the elastic members 50 is fixed to the substrate 10, the second end 52 of each of the elastic members 50 is fixed to the movable member 20, and an extension direction of each of the elastic members 50 is identical to the moving direction S of the movable member 20. Therefore, when the flexible sheet 30 is pulled to allow each of the elastic members 50 to generate an elastic pulling force, the direction of the elastic pulling force can be identical to the moving direction S of the movable member. Hence, the elastic pulling force can be prevented from being dispersed or attenuated to affect the retraction performance of the flexible sheet 30.

It is understood that, the structure of the first embodiment may be adjusted according to practical application demands. In the following second to fifth embodiments, the first embodiment is taken as a basis with some of the structures thereof being modified or added. Descriptions are provided as below with accompanied drawings.

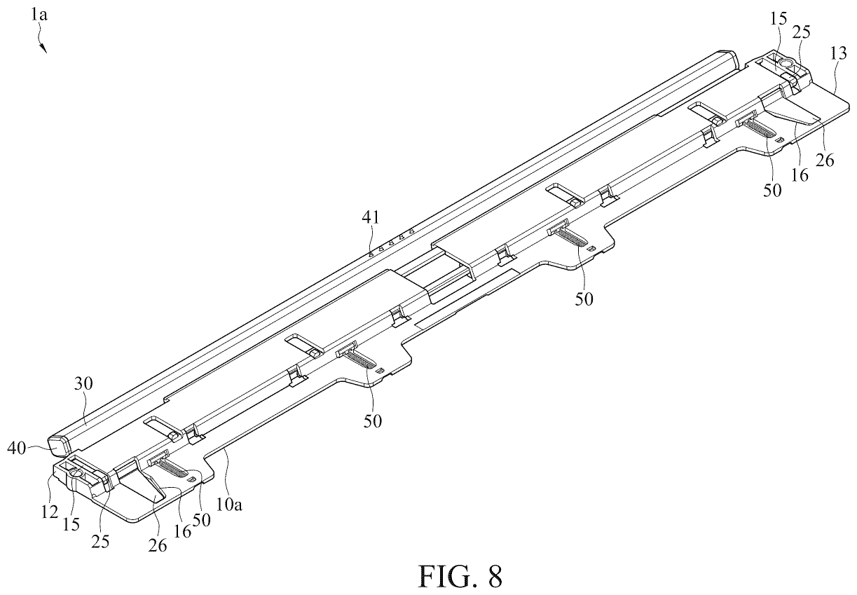

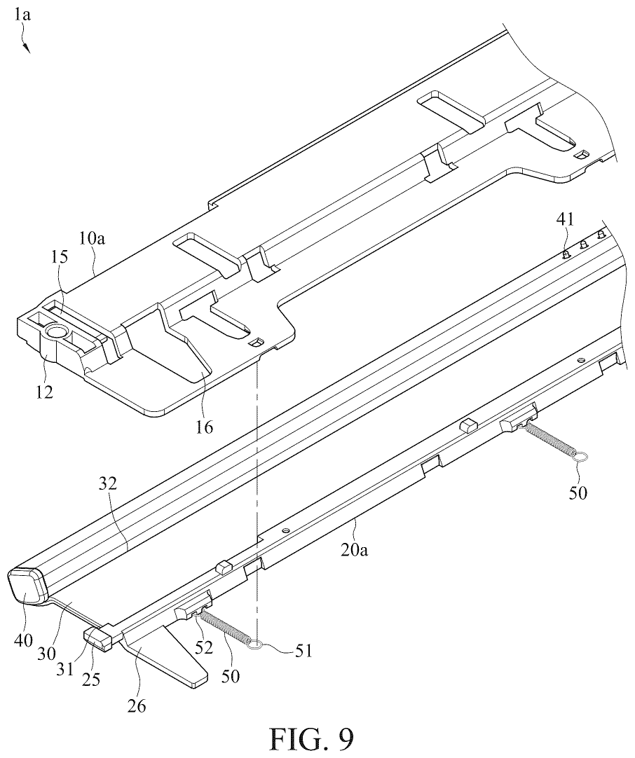

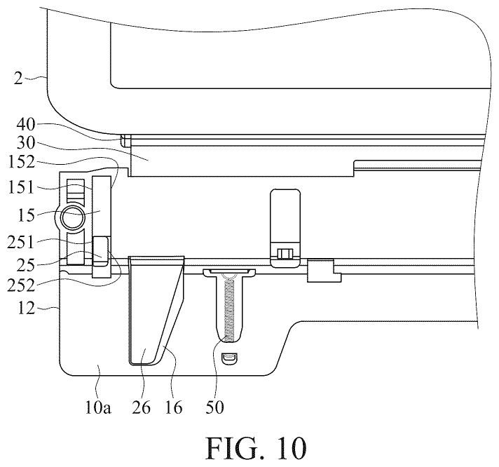

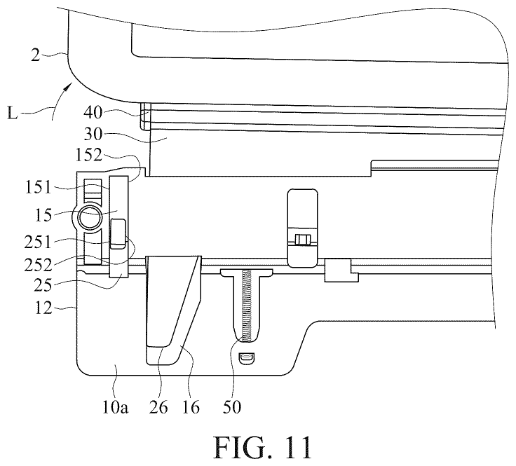

FIG. 8 illustrates a perspective view of a retractable connection device according to a second embodiment of the instant disclosure. FIG. 9 illustrates an enlarged partial exploded view of the retractable connection device of the second embodiment of the instant disclosure. FIG. 10 illustrates an enlarged partial plan view of the retractable connection device of the second embodiment of the instant disclosure. FIG. 11 illustrates a schematic view showing the retractable performance operation of the flexible sheet of the retractable connection device of the second embodiment of the instant disclosure. As shown in FIG. 8 to FIG. 11, in the second embodiment, the retractable connection device 1a also comprises a substrate 10a, a movable member 20a, a flexible sheet 30, a device connection member 40, and a plurality of elastic member 50; the movable member 20 is on the substrate 10, and the movable member 20a is slidable with respect to the substrate 10a along the moving direction S. The first side 31 of the flexible sheet 30 is fixed to the movable member 20a. The device connection member 40 is connected to the second side 32 of the flexible sheet 30. The first end 51 of each of the elastic members 50 is connected to the substrate 10a, and the second end 52 of each of the elastic members 50 is connected to the movable member 20a.

As shown in FIG. 8 to FIG. 11, the difference between the second embodiment and the first embodiment at least lies in that, in the second embodiment, the substrate 10a has a first plate side 12, a second plate side 13 opposite to the first plate side 12, two first limiting grooves 15, and two second limiting grooves 16. The two first limiting grooves 15 are respectively adjacent to the first plate side 12 and the second plate side 13, the two second limiting grooves 16 are between the two first limiting grooves 15, and the two second limiting grooves 16 are also respectively adjacent to the first plate side 12 and the second plate side 13. The movable member 20a has two first limiting plates 25 and two second limiting plates 26, the two first limiting plates 25 are slidably arranged in the two first limiting grooves 15, respectively, and the two second limiting plates 26 are slidably arranged in the two second limiting grooves 16, respectively.

Moreover, as shown in FIG. 8 to FIG. 11, in this embodiment, the substrate 10a is a cover plate. The substrate 10a is on the movable member 20a, the flexible sheet 30, and the device connection member 40, and the first side 31 of the flexible sheet 30 is retained inside the substrate 10a.

Furthermore, as shown in FIG. 8 to FIG. 11, taking the first limiting groove 15 and the first limiting plate 25 adjacent to the first plate side 12 as an example, the extension direction of the first limiting groove 15 is identical to the moving direction S. The first limiting groove 15 has a first side surface 151 and a second side surface 152, in which the first side surface 151 is nearer to the first plate side 12 as compared with the second side surface 152 (in other words, in some embodiments, a distance between the first side surface 151 and the first plate side 12 is less than a distance between the second side surface 152 and the first plate side 12). The entirety of the first limiting plate 25 of the movable member 20a is nearer to the first side surface 151; specifically, in some embodiments, the first limiting plate 25 has a first side edge 251 and a second side edge 252, the first side edge 251 is nearer to the first plate side 12 as compared with the second side edge 252 (in other words, in some embodiments, a distance between the first side edge 251 and the first plate side 12 is less than a distance between the second side edge 252 and the first plate side 12), and a distance between the first side edge 251 and the first side surface 151 is less than a distance between the second side edge 252 and the second side surface 152. In this embodiment, the first side edge 251 of the first limiting plate 25 almost contacts the first side surface 151, while an apparent spacing is between the second side edge 252 and the second side surface 152. Therefore, as shown in FIG. 8 and FIG. 11, when the flexible sheet 30 is pulled to be moved toward the direction away from the substrate 10a and stretched out the substrate 10a, if the user applies force improperly to cause the flexible sheet 30 to be deflected toward the second plate side 13 of the substrate 10a (as indicated by the arrow L shown in FIG. 11), the first side edge 251 of the first limiting plate 25 and the first side surface 151 of the first limiting groove 15 can provide interference action and friction to stop the flexible sheet 30 from continuing to be deflected. Therefore, the movement trajectory of the flexible sheet 30 can be corrected, so that the flexible sheet 30 can be moved retractably along the moving direction S.

Furthermore, as shown in FIG. 8 to FIG. 11, the structures of the second limiting plate 26 and the second limiting groove 16 adjacent to the first plate side 12 may be similar or identical with the structures of the first limiting plate 25 and the first limiting groove 15. In other words, in some embodiments, the entirety of the second limiting plate 26 is nearer to a side surface of the second limiting groove 16 adjacent to the first plate side 12. Therefore, when the flexible sheet 30 is deflected toward the second plate side 13 of the substrate 10a during the retraction of the flexible sheet 30, the movement trajectory of the flexible sheet 30 can be corrected collectively through the first limiting plate 25 and the second limiting plate 26 adjacent to the first plate side 12, thereby preventing the flexible sheet 30 from being deflected during the retraction of the flexible sheet 30. Likewise, the entirety of the second limiting plate 26 which is adjacent to a side surface of the second limiting groove 16 adjacent to the second plate side 13, thereby preventing the flexible sheet 30 from being deflected toward the first plate side 12 of the substrate 10a during the retraction of the flexible sheet 30.

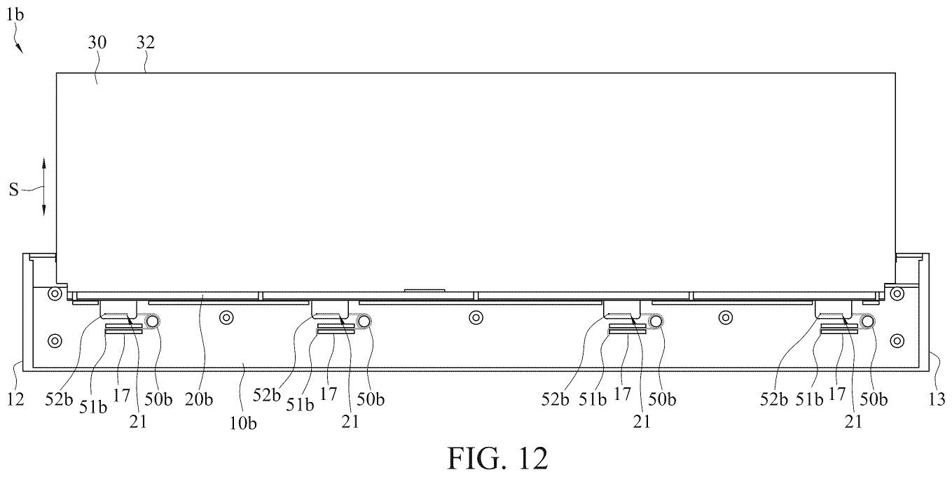

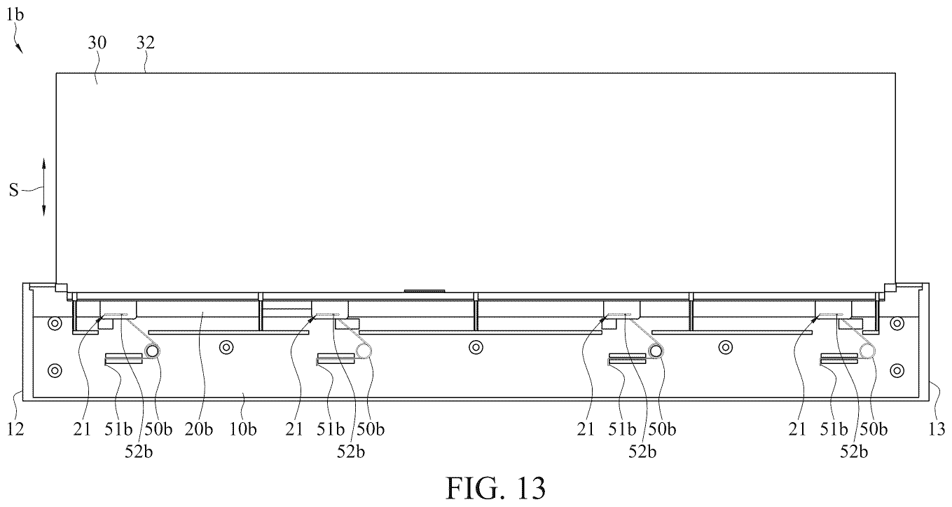

FIG. 12 illustrates a plan view of a retractable connection device according to a third embodiment of the instant disclosure. FIG. 13 illustrates a schematic view showing the retractable operation of the flexible sheet of the retractable connection device of the third embodiment of the instant disclosure. As shown in FIG. 12 and FIG. 13, the difference between the third embodiment and the first embodiment at least lies in that, in the third embodiment, each of the elastic members 50b of the retractable connection device 1b is a torsion spring, the movable member 20b further has a plurality of slide grooves 21 spaced apart from each other, a first end 51b of each of the elastic members 50b is fixed to the substrate 10b. For example, in this embodiment, the substrate 10b is provided with a plurality of fixation portions 17 spaced apart from each other to correspond to the elastic members 50b, respectively. The first end 51b of each of the elastic members 50b is fixed to a corresponding one of the fixation portions 17, and the second end 51b of each of the elastic members 50 is slidably connected to a corresponding one of the slide grooves 21 of the movable member 20b. Therefore, when the flexible sheet 30 is pulled to be moved toward the direction away from the substrate 10b and stretched out of the substrate 10b (as shown in FIG. 13), the movable member 20b can drive the second end 52b of each of the elastic members 50b to be moved toward the direction away from the substrate 10b and slide along the corresponding one of the slide grooves 21, so that the elastic members 50b are twisted and deformed to store elastic forces. When the flexible sheet 30 is released and the external force is removed, each of the elastic members 50b can be recovered resiliently using the elastic force to drive the flexible sheet 30 to be moved toward the substrate 10 and retracted back to the substrate 10b (as shown in FIG. 12).

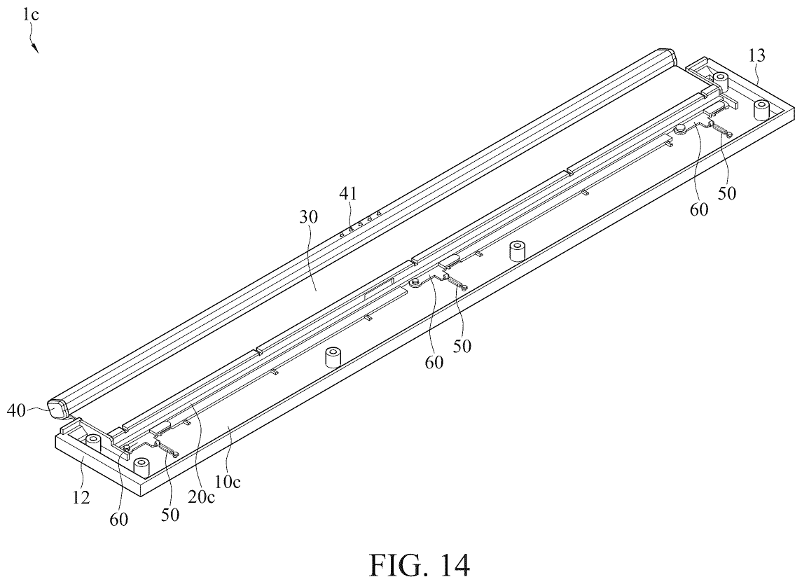

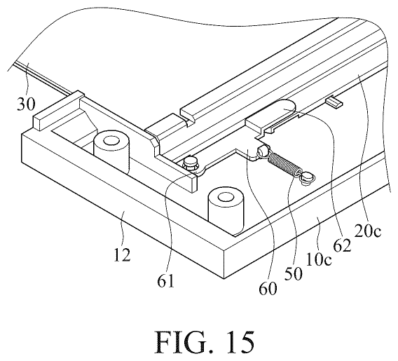

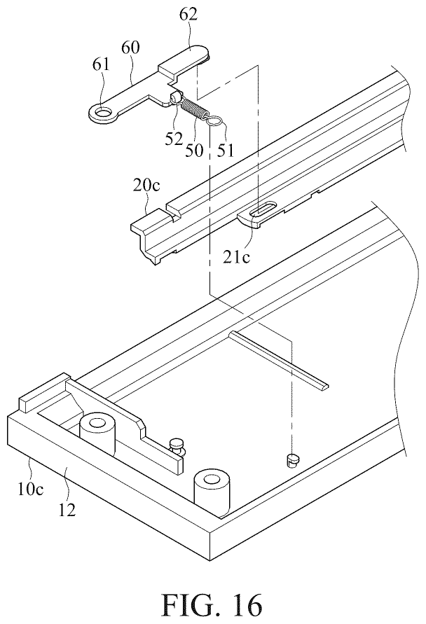

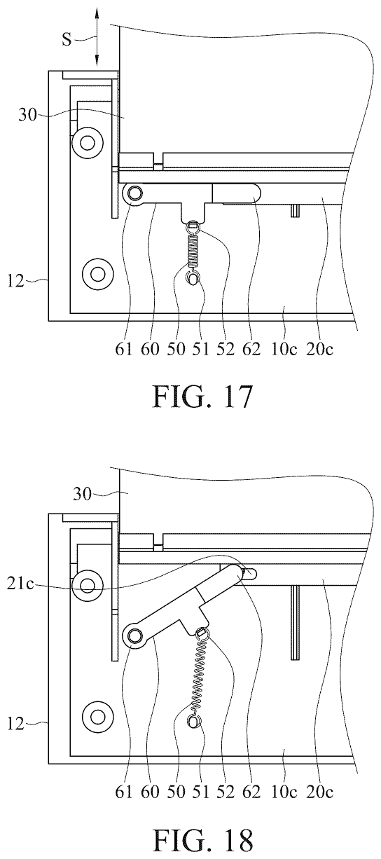

FIG. 14 illustrates a perspective view of a retractable connection device according to a fourth embodiment of the instant disclosure. FIG. 15 illustrates an enlarged partial perspective view of the retractable connection device of the fourth embodiment of the instant disclosure. FIG. 16 illustrates an enlarged partial exploded view of the retractable connection device of the fourth embodiment of the instant disclosure. FIG. 17 illustrates a partial plan view of the retractable connection device of the fourth embodiment of the instant disclosure. FIG. 18 illustrates a schematic view showing the retractable operation of the flexible sheet of the retractable connection device of the fourth embodiment of the instant disclosure. As shown in FIG. 14 to FIG. 18, in the fourth embodiment, the retractable connection device 1c also comprises a substrate 10c, a movable member 20c, a flexible sheet 30, a device connection member 50, and a plurality of elastic members 50. The difference between the fourth embodiment and the first embodiment at least lies in that, in this embodiment, the retractable connection device 1c further comprises a plurality of swing bars 60 spaced apart from each other. Each of the swing bars 60 has a pivot end 61 and a slide end 62 opposite to the pivot end 61. The pivot end 61 is pivotally connected to the substrate 10c, so that each of the swing bars 60 can be swung with respect to the substrate 10c by taking the pivot end 61 as an axis. The slide end 62 of each of the swing bars 60 is slidably connected to the movable member 20c. For example, in this embodiment, the movable member 20c has a plurality of slide grooves 21c spaced apart from each other, and the slide end 62 of each of the swing bars 60 is slidably arranged in a corresponding one of the slide grooves 21c.

Moreover, as shown in FIG. 14 to FIG. 18, the first end 51 of each of the elastic members 50 is fixed to the substrate 10c, and the second end 52 of each of the elastic members 50 is fixed between the pivot end 61 and the slide end 62 of a corresponding one of the swing bars 60. Therefore, when the flexible sheet 30 is pulled to be moved toward the direction away from the substrate 10c and stretched out of the substrate 10c (as shown in FIG. 18), the movable member 20c can drive the slide end 62b of each of the swing bars 60 to be moved toward the direction away from the substrate 10c and slide along the corresponding one of the slide grooves 21c, so that the swing bars 60 are swung with respect to the substrate 10c to drive the elastic members 50 to be deformed, thereby allowing each of the elastic members 50 to generate an elastic pulling force toward the substrate 10c for a corresponding one of the swing bars 60. When the flexible sheet 30 is released and the external force is removed, the elastic pulling force allows the swing bars 60 to drive the flexible sheet 30 to be moved toward the substrate 10c and retracted back to the substrate 10c, thereby allowing the elastic members 50 to be recovered resiliently (as shown in FIG. 17).

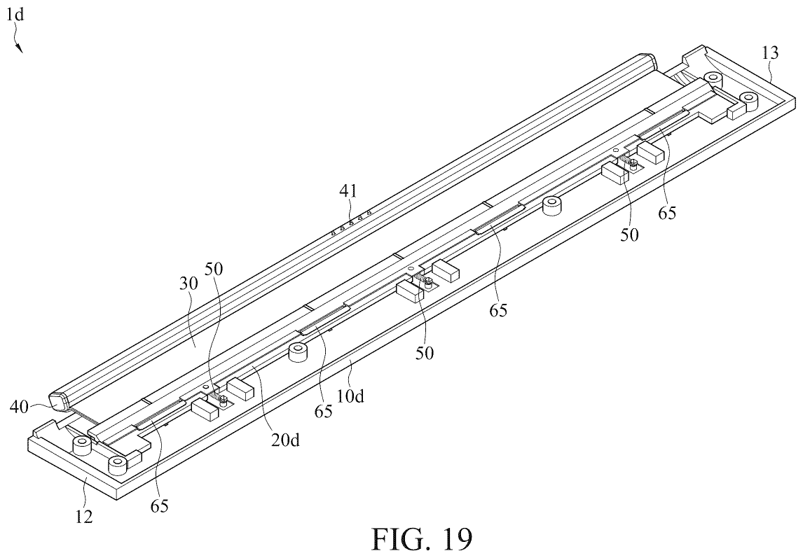

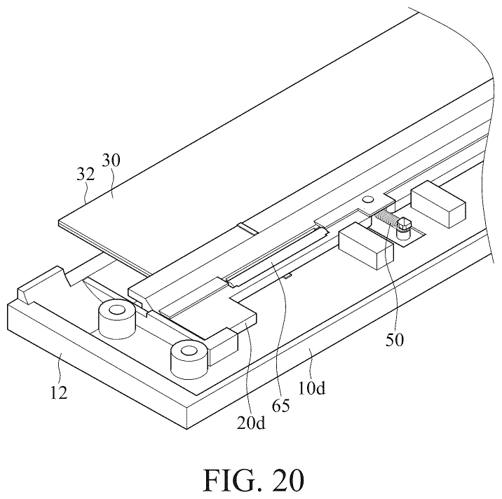

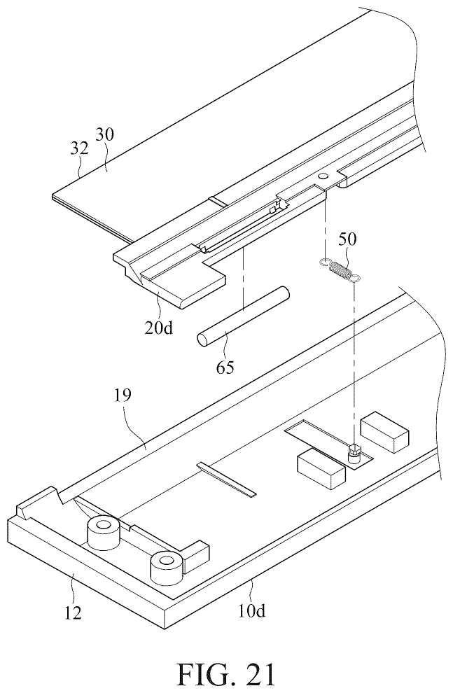

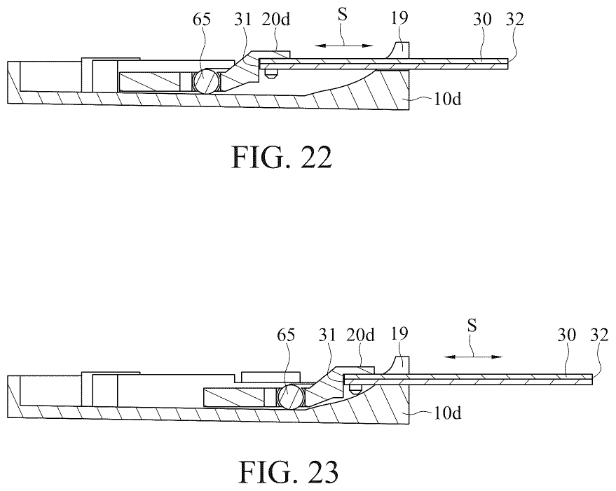

FIG. 19 illustrates a perspective view of a retractable connection device according to a fifth embodiment of the instant disclosure. FIG. 20 illustrates an enlarged partial perspective view of the retractable connection device of the fifth embodiment of the instant disclosure. FIG. 21 illustrates an enlarged partial exploded view of the retractable connection device of the fifth embodiment of the instant disclosure. FIG. 22 illustrates a cross-sectional view of the retractable connection device of the fifth embodiment of the instant disclosure. FIG. 23 illustrates a schematic view showing the retractable operation of the flexible sheet of the retractable connection device of the fifth embodiment of the instant disclosure. As shown in FIG. 19 to FIG. 23, in the fifth embodiment, the retractable connection device 1d also comprises a substrate 10d, a movable member 20d, a flexible sheet 30, a device connection member 40, and a plurality of elastic members 50. The difference between the fifth embodiment and the first embodiment at least lies in that, in this embodiment, the retractable connection device 1d further comprises at least one rollable member 65. In this embodiment, the retractable connection device 1d comprises a plurality of the rollable members 65 spaced apart from each other. Each of the rollable members 65 is rotatably connected to the movable member 20d, and an outer periphery of each of the rollable members 65 contacts a surface of the substrate 10d. In some embodiments, the rollable member 65 may be a rollable pin, a rollable ball, a rollable cylinder, or other round objects.

Therefore, as shown in FIG. 22 and FIG. 23, when the flexible sheet 30 is applied with a force to be moved retractably along the moving direction S, the movable member 20d and the substrate 10d rollably contact each other indirectly through the rollable members 65, thereby greatly reducing the friction between the movable member 20d and the substrate 10 and making the operation of the flexible sheet 30 more smoothly.

Moreover, as shown in FIG. 21 to FIG. 23, in this embodiment, one side of the substrate 10d has a limiting protrusion 19 between the rollable member 65 and the second side 32 of the flexible sheet 30. Therefore, when the flexible sheet 30 is applied with a force to be moved toward the direction away from the substrate 10d, the configuration of the limiting protrusion 19 prevents the flexible sheet 30 from being overly stretched and prevents the movable member 20d from totally detaching off the substrate 10d.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A retractable connection device adapted to be assembled with an electronic device, wherein the retractable connection device comprises:
a substrate;
a movable member on the substrate, wherein the movable member is selectively slidable with respect to the substrate along a moving direction;
a flexible sheet having a first side and a second side opposite to the first side, wherein the first side is fixed to the movable member;
a device connection member connected to the second side of the flexible sheet; and
a plurality of elastic members between the movable member and the substrate and spaced apart from each other, wherein each of the elastic members generates an elastic pulling force toward the substrate for the movable member.

2. The retractable connection device according to claim 1, wherein each of the elastic members has a first end and a second end, the first end is connected to the substrate, and the second end is connected to the movable member.

3. The retractable connection device according to claim 2, wherein each of the elastic members is a tension spring, the first end of each of the elastic members is fixed to the substrate, and the second end of each of the elastic members is fixed to the movable member.

4. The retractable connection device according to claim 3, wherein each of the elastic members has an extension direction, and the extension direction is identical to the moving direction.

5. The retractable connection device according to claim 2, wherein each of the elastic members is a torsion spring, the movable member has a plurality of slide grooves, the first end of each of the elastic members is fixed to the substrate, and the second end of each of the elastic members is slidably connected to a corresponding one of the slide grooves of the movable member.

6. The retractable connection device according to claim 1, wherein the substrate is provided with a first guiding member, the movable member is provided with a second guiding member, the first guiding member and the second guiding member extend along the moving direction, and the second guiding member is slidably connected to the first guiding member.

7. The retractable connection device according to claim 1, wherein the substrate has a first limiting groove, a first plate side, and a second plate side opposite to the first plate side, the first limiting groove is adjacent to the first plate side, the first limiting groove has a first side surface and a second side surface, and the first side surface is nearer to the first plate side as compared with the second side surface; the movable member has a first limiting plate, the first limiting plate is in the first limiting groove, the first limiting plate has a first side edge and a second side edge, the first side edge is nearer the first plate side as compared with the second side edge, and a distance between the first side edge and the first side surface is less than a distance between the second side edge and the second side surface.

8. The retractable connection device according to claim 1, further comprising a plurality of swing bars, wherein each of the swing bars has a pivot end and a slide end, the pivot end is pivotally connected to the substrate, the slide end is slidably connected to the movable member, a first end of each of the elastic members is fixed to the substrate, and a second end of each of the elastic members is fixed between the pivot end and the slide end of a corresponding one of the swing bars.

9. The retractable connection device according to claim 1, further comprising a rollable member, wherein the rollable member is rotatably connected to the movable member, and an outer periphery of the rollable member contacts a surface of the substrate.

10. An input apparatus adapted to be assembled with an electronic device, wherein the input apparatus comprises a retractable connection device according to claim 1; and
an input unit connected to the substrate of the retractable connection device.

11. The input apparatus according to claim 10, wherein each of the elastic members has a first end and a second end, the first end is connected to the substrate, and the second end is connected to the movable member.

12. The input apparatus according to claim 11, wherein each of the elastic members is a tension spring, the first end of each of the elastic members is fixed to the substrate, and the second end of each of the elastic members is fixed to the movable member.

13. The input apparatus according to claim 12, wherein each of the elastic members has an extension direction, and the extension direction is identical to the moving direction.

14. The input apparatus according to claim 11, wherein each of the elastic members is a torsion spring, the movable member has a plurality of slide grooves, the first end of each of the elastic members is fixed to the substrate, and the second end of each of the elastic members is slidably connected to a corresponding one of the slide grooves of the movable member.

15. The input apparatus according to claim 10, wherein the substrate is provided with a first guiding member, the movable member is provided with a second guiding member, the first guiding member and the second guiding member extend along the moving direction, and the second guiding member is slidably connected to the first guiding member.

16. The input apparatus according to claim 10, wherein the substrate has a first limiting groove, a first plate side, and a second plate side opposite to the first plate side, the first limiting groove is adjacent to the first plate side, the first limiting groove has a first side surface and a second side surface, and the first side surface is nearer to the first plate side as compared with the second side surface; the movable member has a first limiting plate, the first limiting plate is in the first limiting groove, the first limiting plate has a first side edge and a second side edge, the first side edge is nearer the first plate side as compared with the second side edge, and a distance between the first side edge and the first side surface is less than a distance between the second side edge and the second side surface.

17. The input apparatus according to claim 10, further comprising a plurality of swing bars, wherein each of the swing bars has a pivot end and a slide end, the pivot end is pivotally connected to the substrate, the slide end is slidably connected to the movable member, a first end of each of the elastic members is fixed to the substrate, and a second end of each of the elastic members is fixed between the pivot end and the slide end of a corresponding one of the swing bars.

18. The input apparatus according to claim 10, further comprising a rollable member, wherein the rollable member is rotatably connected to the movable member, and an outer periphery of the rollable member contacts a surface of the substrate.

19. The input apparatus according to claim 10, wherein the device connection member of the retractable connection device has an electrical connector, and the electrical connector is electrically connected to the input unit.
